(19) United States
(12) Patent Application Publication
(10) Pub. No.: US 2016/0162055 A1
(43) Pub. Date: Jun. 9, 2016

(54) STRUCTURE FOR A TOUCH-CONTROL TOOL

(71) Applicant: Golden Right Company Ltd., New Taipei City (TW)

(72) Inventor: Te-Hsiang FANG, New Taipei City (TW)

(21) Appl. No.: 14/560,716

(22) Filed: Dec. 4, 2014

(51) Int. Cl. G06F 3/0354; G06F 3/041

(52) U.S. Cl. CPC G06F 3/03546; G06F 3/041; G06F 2203/04103

(57) ABSTRACT

A structure for a touch-control tool includes a grip handle and a touch-control assembly. The grip handle includes an operating end. The touch-control assembly is disposed on the operating end, and the touch-control assembly includes a ball bearing, a touch-control pad, and an elastic element. The ball bearing protrudes from the operating end, a ball base is disposed on the touch-control pad, the elastic element is disposed between the ball base and the operating end, and the ball bearing contacts the ball base in a movable manner therein by means of the elastic element, thereby enhancing operation accuracy and smoothness.

### BACKGROUND

1. Technical Field

The present invention relates to a tool for operating a touch screen and, in particular, to an improved structure for a touch-control tool.

2. Related Art

Since smartphones and tablets are increasingly popular, touch screens are necessary for operation of the aforesaid 3C products or the like in the modern time. Conventional touch screens include resistive touch screens and capacitive touch screens, and no matter which kind, most of them can be operated by touch/press by users' hands. Particularly in terms of the capacitive touch screens, the touch operations thereof are performed through the capacitive changes generated by hand contact with the touch screens. For more convenient touch operations, touch-control pens are designed to adapt to different types of touch screens. Conventional capacitive type touch-control pens, such as utility model patent no. M418337 in Taiwan, disclose a touch-control pen characterized in that, a touch-control portion connected by a metallic spring is disposed on an end portion of a pen-holder shaped grip handle, and the metallic spring enables flexibility and electrical conductivity to facilitate operations by gripping of the hand.

However, the touch-control pen enables the flexible deformation between the grip handle and the touch-control portion by the metallic spring alone, and no limitation structures are provided to restrict the elastic swaying/shaking of the metallic spring, so the metallic spring cannot be too long in length and deformation of the metallic spring cannot be too great, or the operation accuracy is affected when the swaying/shaking is too great, which is a defect in need of improvement.

In view of the foregoing, the inventor made various studies to improve the above-mentioned problems to realize the improvements, on the basis of which the present invention is accomplished.

### BRIEF SUMMARY

It is an object of the present invention to provide an improved structure for a touch-control tool which can increase a total length of an elastic element of the touch-control tool, and thereby enhance the flexibility and deformation ability thereof, so as to provide more operating angles to cooperate with different operation habits of users.

It is another object of the present invention to provide an improved structure for a touch-control tool which can reduce swaying/shaking of the elastic element while the total length of the elastic element increases, so as to enhance operation accuracy.

Accordingly, the present invention provides an improved structure for a touch-control tool, comprising a grip handle, and a touch-control assembly. The grip handle includes an operating end. The touch-control assembly is disposed on the operating end. The touch-control assembly includes a ball bearing, a touch-control pad, and an elastic element. The ball bearing protrudes from the operating end, a ball base is disposed on the touch-control pad, the elastic element is disposed between the ball base and the operating end, and the ball bearing contacts the ball base in a movable manner therein by means of the elastic element. By disposing the ball bearing inside the elastic element, swaying/shaking of the elastic element does not occur at random, and consequently swaying/shaking of the touch-control pad is also reduced, and therefore operation accuracy is enhanced. In addition, by increasing the total length of the elastic element, flexibility and deformation ability can also be improved to facilitate smooth operation.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective appearance view of the present invention.

FIG. 2 is a perspective exploded view of an operating end of the present invention.

FIG. 3 is a perspective assembled view of the operating end of the present invention.

FIG. 4 is a cross-sectional assembled view of the operating end of the present invention.

FIG. 5 is a schematic use state view illustrating the present invention is used on a touch screen.

FIG. 6 is a schematic view illustrating the present invention in use can sway freely.

FIG. 7 is a schematic view of a writing end of the present invention.

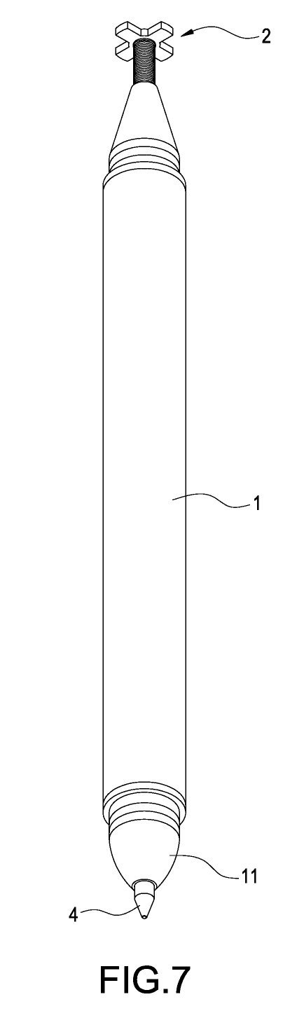

### DETAILED DESCRIPTION

In the following, detailed descriptions along with accompanied drawings are given to better explain the features and technical contents of the present invention. However, the following descriptions and the accompanied drawings are for reference and illustration only, and are not intended to limit the scope of the present invention.

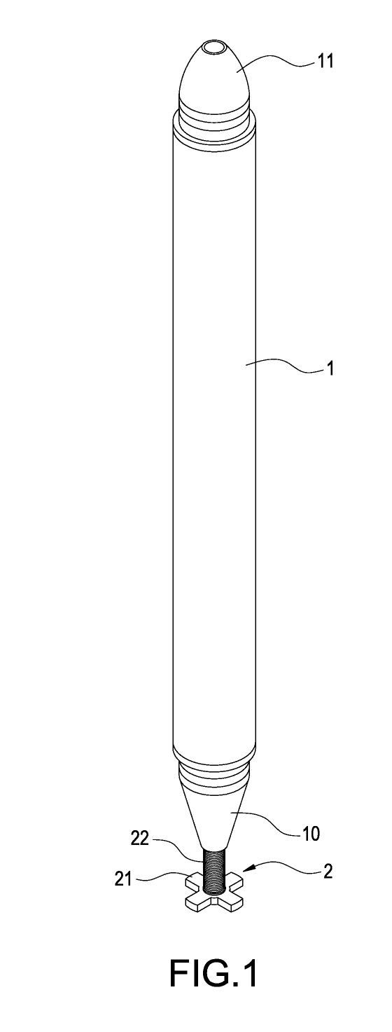

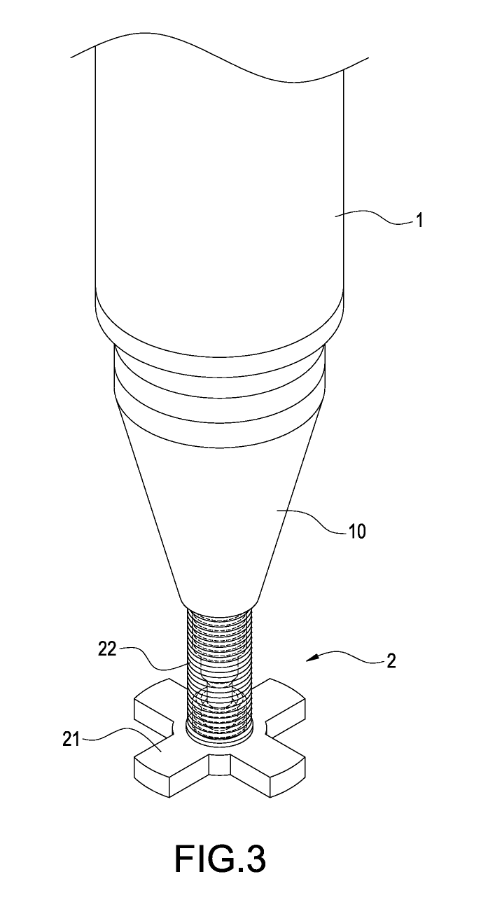

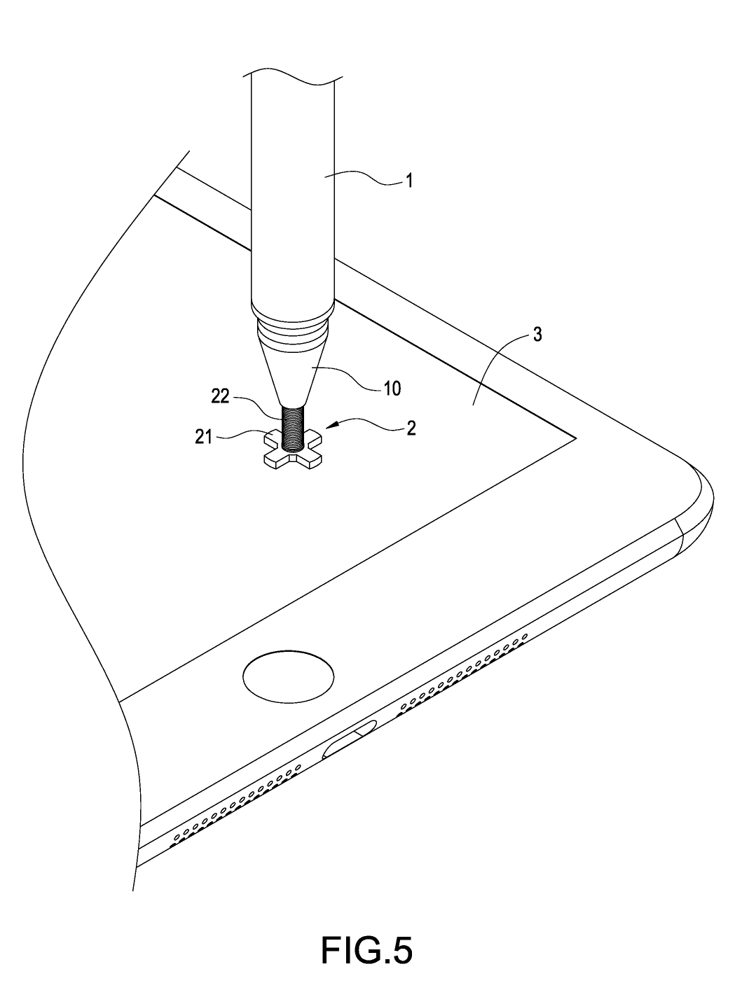

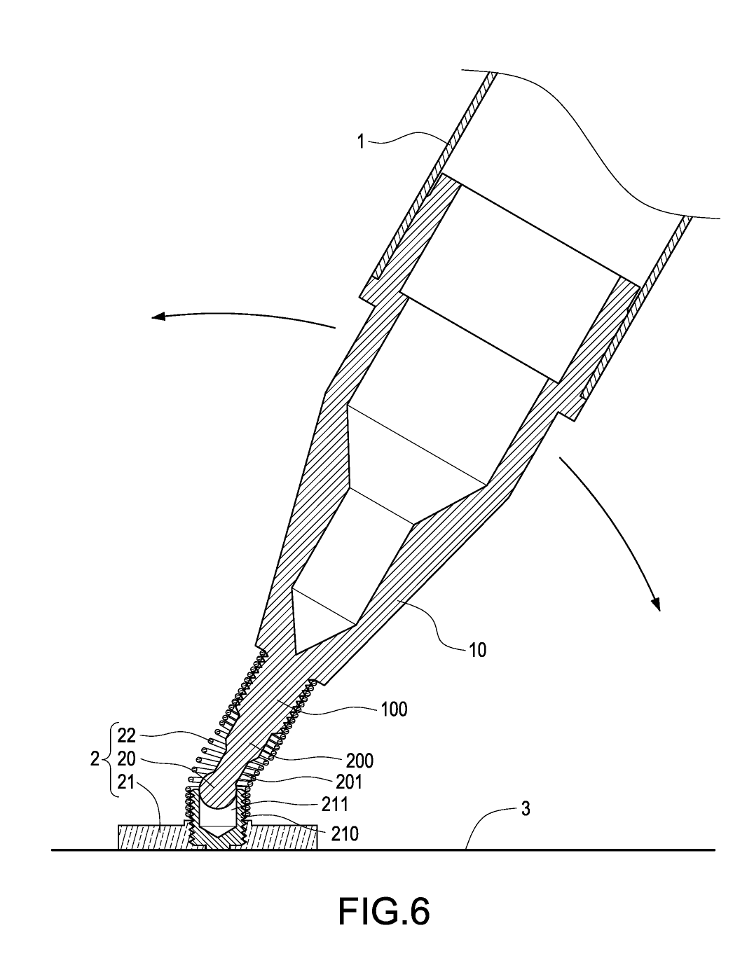

Please refer to FIGS. 1, 2 and 3 which are a perspective appearance view of the present invention, a perspective exploded view of an operating end of the present invention, and a perspective assembled view of the operating end of the present invention, respectively. The present invention provides an improved structure for a touch-control tool for use with, for example, a resistive or capacitive touch screen 3 (see FIG. 5). The touch-control tool can be in a pen-holder shape for easy grip by a user to touch and operate the touch screen 3 according to common handwriting habits. The touch-control tool includes a grip handle 1 and a touch-control assembly 2. The grip handle 1 can be in a pen-holder shaped and has two ends, wherein one end is an operating end 10, and the other end is a writing end 11. Therefore, as shown in FIG. 5 and FIG. 6, the grip handle 1 facilitate gripping by a user, the touch operations can be performed by using the operating end 10 to touch the touch screen 3 according to common handwriting habits. In addition, the grip handle 1 can be turned to the writing end 11, and then a pen nib 4 protruding from the writing end 11 can be used to write on an ordinary paper, thus increasing practicability of the touch-control tool.

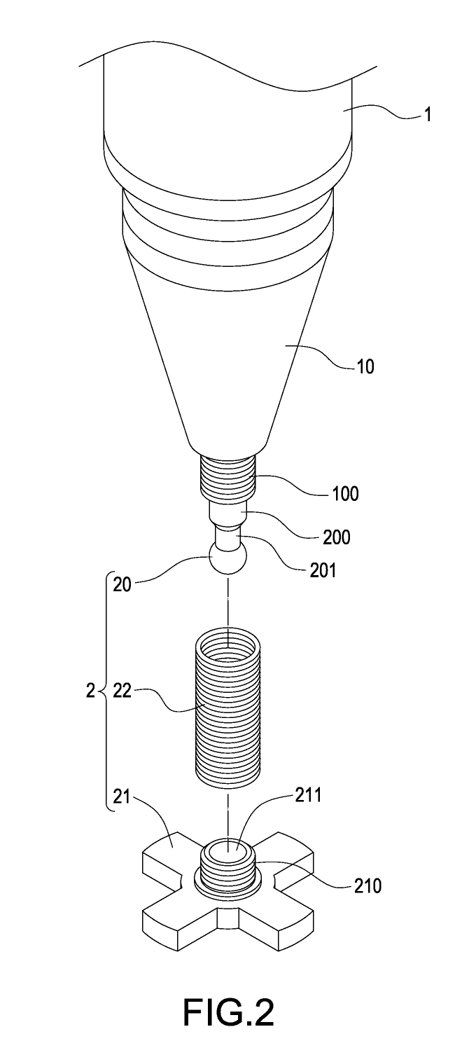

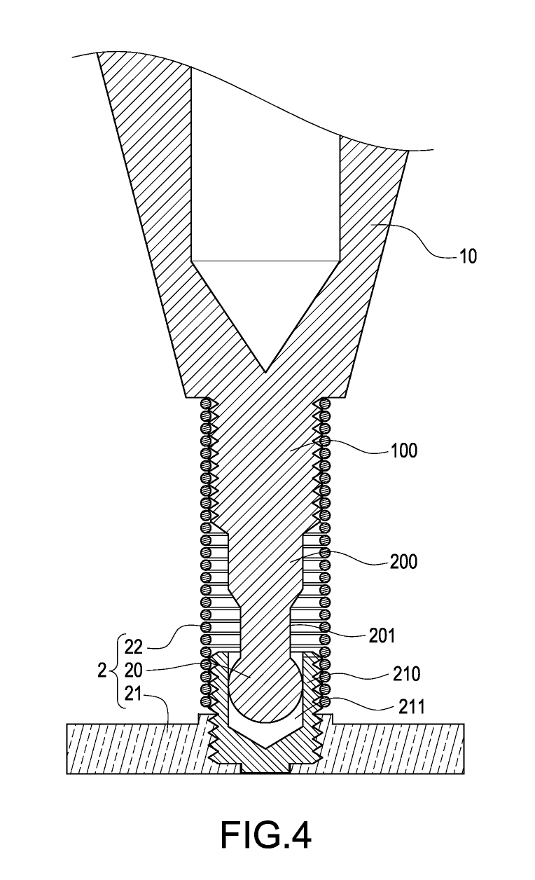

Referring to FIGS. 2, 3, and 4, the touch-control assembly 2 is disposed on an operating end 10 of the grip handle 1. The present invention mainly improves the touch-control assembly 2. The touch-control assembly 2 includes a ball bearing 20, a touch-control pad 21, and an elastic element 22. The ball bearing 20 protrudes from the operating end 10 of the grip handle 1. According to the embodiment of the present invention, a pillar base 100 extends from an end portion of the operating end 10, and the ball bearing 20 is connected to the pillar base 100 by an extending portion 200. The extending portion 200 includes a ring-shaped recess 201 adjacent to the ball bearing 20, so as to reduce an outer diameter of a contact portion between the extending portion 200 and the ball bearing 20, and thereby the ball bearing 20 can obtain a larger spherical surface. The touch-control pad 21 can be in a round shape (not illustrated) or in a cross shape. When the touch-control pad 21 is in the cross shape, it provides an alignment effect similar to aiming a target, so that a correct position can be touched more accurately by the user's hand. A ball base 210 is disposed on the touch-control pad 21, and a ball socket 211 is in the ball base 210. The elastic element 22 is disposed between the ball base 210 and the operating end 10, and the ball bearing 20 contacts the ball base 210 in a movable manner thereon by means of the elastic element 22. The elastic element 22 encloses outside the pillar base 100 and the ball base 210. The pillar base 100 and ball base 210 respectively include a thread shaped outer profile, so as to improve the coupling strength when they are enclosed by the elastic element 22.

Therefore, by using the constructions mentioned above, the improved structure for the touch-control tool of the present invention is obtained.

As shown in FIGS. 5 and 6, when using the touch-control tool of the present invention to operate the touch screen 3, it only requires the user to employ his/her hand to hold the grip handle 1 to control the same, according to common handwriting habits, and such that the touch-control pad 21 can touch/strike a desired position on the touch screen 3, or can perform dragging tasks and other tasks. In a process of holding to control the grip handle 1, the ball bearing 20 is inserted in the elastic element 22, and the ball bearing 20 contacts against the touch-control pad 21 in a movable manner thereon when the touch-control pad 21 touches/strikes a position on the touch screen 3 to exert force, so the possibility of sway/shaking of the elastic element 22 is reduced, and thereby operation accuracy is improved. At the same time, the elastic element 22 simultaneously allows flexible deformation to cooperate with an inclined angle between the grip handle 1 and the touch-control pad 21, thus facilitating smooth operations, and more angular changes in operation can be carried out to adapt to different operation habits of users.

It is worth mentioning that in the design, a length of the elastic element 22 of the touch-control assembly 2 is preferably over 5 mm, and a length of the extending portion 200 can increase to shorten a distance between the ball bearing 20 and the ball base 210.

In summary, the present invention is an exceptional utility product and surely can achieve the anticipated objects and resolve the defects of the conventional techniques, and the present invention complete meets the requirements of a utility patent, namely novelty and non-obviousness. Hence, a request to patent the present invention is filed based on the patent laws. Examination is kindly requested, and allowance of the present patent application is solicited to protect the rights of the inventor.

It is to be understood that the above descriptions are merely preferable embodiment of the present invention and not intended to limit the scope of the present invention. Equivalent changes and modifications made in the spirit of the present invention are regarded as falling within the scope of the present invention.

What is claimed is:

1. A structure for a touch-control tool, comprising:
a grip handle including an operating end; and
a touch-control assembly disposed on the operating end, the touch-control assembly including a ball bearing, a touch-control pad, and an elastic element, wherein the ball bearing protrudes from the operating end, a ball base is disposed on the touch-control pad, the elastic element is disposed between the ball base and the operating end, and the ball bearing contacts the ball base in a movable manner therein by means of the elastic element.

2. The structure for the touch-control tool of claim 1, wherein the grip handle is in a pen-holder shape

3. The structure for the touch-control tool of claim 1, wherein the grip handle further includes a writing end, and a pen nib protrudes from the writing end.

4. The structure for the touch-control tool of claim 1, wherein a pillar base extends from an end portion of the operating end, and the ball bearing is connected to the pillar base by an extending portion.

5. The structure for the touch-control tool of claim 4, wherein a ring-shaped recess is formed on the extending portion and is close to the ball bearing.

6. The structure for the touch-control tool of claim 4, wherein the elastic element encloses outside the pillar base and the ball base.

7. The structure for the touch-control tool of claim 6, wherein the pillar base and ball base respectively include a thread shaped outer profile.

8. The structure for the touch-control tool of claim 1, wherein a length of the elastic element is over 5 mm.

9. The structure for the touch-control tool of claim 1, wherein the touch-control pad is in a round shape or in a cross shape.

10. The structure for the touch-control tool of claim 1, wherein a ball socket is formed in the ball base, and the ball bearing contacts the ball socket of the ball base in a movable manner therein.
